(19) United States
(12) Patent Application Publication
(10) Pub. No.: US 2003/0225844 A1
(43) Pub. Date: Dec. 4, 2003

(54) Information collection system using electronic mails

(75) Inventor: Naoto Kuroda, Nagano-ken (JP)

Correspondence Address: SUGHRUE MION, PLLC, 2100 Pennsylvania Avenue, NW., Washington, DC, 20037-3213, US

(73) Assignee: SEIKO EPSON CORPORATION

(21) Appl. No.: 10/400,077

(22) Filed: Mar. 27, 2003

(30) Foreign Application Priority Data
Mar. 28, 2002 (JP) 2002-93139(P)
Feb. 17, 2003 (JP) 2003-37902(P)

(51) Int. Cl. H04M 11/00; G06F 15/16

(52) U.S. Cl. 709/206; 379/100.08

(57) ABSTRACT

An information collection system of the present invention automatically analyzes electronic mails, which are described in different formats and transmitted from diverse virus eradicating application programs, extracts required information from the analyzed electronic mails, and automatically registers the required information into a database. A diversity of virus eradicating application programs used for protection against viruses run on respective devices and computers connecting with a network. Each of the virus eradicating application programs works individually and, as occasion demands, transmits information including its working record in the form of an electronic mail to a mail server 8 included in the information collection system. The transmitted electronic mails are kept in a mail box 9 of the mail server 8. The information collection system also includes a host computer 10, which stores multiple structural definitions 18 therein. Each structural definition 18 is used to specify the format of an electronic mail and the place in the electronic mail where information required for preparation of a database 17 is written. An information extraction module 12 of the host computer 10 refers to a selected structural definition 18 and extracts the required information from an electronic mail received by a mail receiving module 11. A database registration module 14 registers results of the extraction into the database 17. An aggregation module 15 reads virus eradication information of, for example, past one month from the database 17 and prepares a report.

### BACKGROUND OF THE INVENTION

1. Field of the Invention

The present invention relates to an information collecting system that collects predetermined information by utilizing electronic mails.

2. Description of the Related Art

With the spread of the Internet and the enhanced use of networks, computer viruses cause many troubles in various fields. A virus eradicating application program is generally installed in a device or a computer connecting with a network. The virus eradicating application program examines electronic mails and attached documents and deletes or isolates the electronic mail or the document detected as the virus-infected.

The virus eradicating application program may have the function of reporting results of actions against viruses in the form of electronic mails to a management server. The administrator of the network collects information regarding infection and eradication of viruses, based on the contents of the electronic mails transmitted to the management server.

In a large-scale network, virus eradicating application programs are installed in a diversity of devices including respective clients, a server, and a gateway. These virus eradicating application programs may be identical but are often different, and the electronic mails sent to the management server have different formats. In such cases, collection of the virus-related information imposes extreme burden on the administrator of the network.

This problem is not restricted to the case of collecting information for the purpose of virus eradication, but is commonly found on the occasions of collecting information from electronic mails described in different formats.

### SUMMARY OF THE INVENTION

The object of the present invention is thus to provide a technique that automatically analyzes electronic mails described in various formats and extracts required information from the analyzed electronic mails.

In order to attain at least part of the above and the other related objects, the present invention is directed to an information collection system that collects predetermined information from electronic mails. The information collection system stores multiple structural definitions corresponding to multiple formats of the electronic mails. Each of the structural definitions is information used to specify the place in the electronic mail where predetermined information as an object of collection is described. The information collection system reads an electronic mail including the predetermined information, refers to an appropriate structural definition corresponding to the format of the electronic mail, and extracts the predetermined information from the electronic mail.

The selective use of the appropriate structural definition corresponding to the format of the electronic mail enables the contents of electronic mails described in various formats to be analyzed effectively and thus ensures extraction of desired information. The electronic mails analyzed by the system of the present invention include those automatically created by application programs, as well as those manually prepared according to a preset format by users. The former includes electronic mails created by diverse virus eradicating application programs.

A variety of methods may be applicable for the selective use of the structural definition. In one preferable embodiment, when the format of the electronic mail is defined corresponding to identification information representing at least part of a sender, a destination, and a title of the electronic mail, the information collection system refers to one of the multiple structural definitions, based on the identification information. The system can acquire the information regarding the sender, the destination, and the title of an electronic mail without analyzing the text of the electronic mail. The use of such identification information allows for the quick and accurate selection of the appropriate structural definition.

For example, electronic mails automatically created by different application programs, such as different virus eradicating application programs, often have different formats. Each of the electronic mails is sent from a client or the like, in which an application program is installed. The format of the electronic mail is thus mapped to the sender of the electronic mail. The information for identifying the sender of each electronic mail, for example, a sender address, is effectively used as the identification information, when the object electronic mails are created by different application programs.

In another example, it is assumed that multiple application programs having different purposes are installed in one client. The respective application programs create electronic mails including diverse pieces of information according to their purposes. These electronic mails generally have different titles. The format of the electronic mail is thus mapped to the title of the electronic mail. The title of the electronic mail is effectively used as the identification information, in the case of processing the information sent from different application programs having different purposes.

In the system of the present invention, the structural definition may be created in various forms. For example, the place of description of the predetermined information may be specified by the number of rows and the number of columns in the text of the electronic mail. In another method, the place of description of the predetermined information may be specified by utilizing at least either of letter strings to be written immediately before and immediately after the predetermined information as the object of extraction. The information as the object of extraction often has a caption. The caption is effectively used to readily specify the place of description of the predetermined information. The identical structural definition is advantageously used for the electronic mails having the different number of rows or columns, as long as the letter strings of the captions or the like are identical with each other.

In the system of the present invention, the structural definition may include various pieces of information, in addition to the contents for specifying the place of description of the predetermined information. For example, the structural definition may include an application condition to specify propriety of application of the structural definition, based on the format of the electronic mail. In another example, the structural definition may include a conversion rule, which is used to convert the predetermined information extracted from the electronic mail into a specified letter string according to contents of the extracted information. Even in the case of addition or change of the structural definitions, the application condition or the conversion rule included in the structural definition desirably ensures collection of the predetermined information without modifying the contents of the processing executed in the information collection system. In one preferable application, the information processing system has a multi-purpose function of comparing the application condition included in the structural definition with the format of the electronic mail, so as to attain the selective use of the appropriate structural definition.

In one preferable embodiment of the present invention, the multiple structural definitions are stored as individual files. This arrangement ensures flexible actions to the changes in type and format of the object electronic mails.

The structural definition may be described in various languages. Markup languages, such as XML, are preferably used, because of their flexibility. In the case where the structural definition is described in a markup language, the application condition, the conversion rule, or another piece of such additional information can readily be included in the structural definition by tags.

In the structure of the present invention, extraction of the predetermined information may be carried out in response to an instruction of an operator. It is, however, preferable, that the operation of extracting the predetermined information is automatically activated at a preset timing. This arrangement further relieves the load of the operator. The timing may be set on a time basis, for example, once a day, or on a volume basis, for example, once per preset number of non-processed electronic mails or once per preset amount of data.

The extracted information is effectively used in various forms. For example, preset aggregation data may be generated according to the extracted information. One applicable procedure stores the extracted information in a database and then generates the aggregation data. The aggregation may be carried out in response to an instruction of the operator or may be carried out automatically at a predetermined timing, for example, at a fixed period set in advance or at the time when a fixed amount of data is accumulated. Otherwise generation of the aggregation data may be carried out in an event driven manner with a trigger by the action of reading an electronic mail.

A diversity of settings may be applied for the contents of the aggregation data. For example, when the electronic mail includes information regarding a virus infection status, the generated aggregation data may represent the number of transmission of virus-infected files by each sender of the virus-infected files. Such aggregation data is effectively used to specify the device as the source of infection of the virus, and is especially effective for the action against a certain type of the virus that automatically sends virus-infected electronic mails to all the mail addresses included in an address book stored in a client computer. In this application, generation of the aggregation data in the event driven manner is preferable for the quick action.

The extracted information or the result of aggregation may be distributed to a preset destination via the network or may be shown in the form of a Web page or the like to be accessible by each user.

The present invention is not restricted to the information collection system, but may be actualized by an information processing method, a computer program that causes a computer to collect information, and a computer readable recording medium in which such a computer program is recorded. Typical examples of the storage medium include flexible disks, CD-ROMs, magneto-optic discs, IC cards, ROM cartridges, punched cards, prints with barcodes or other codes printed thereon, internal storage devices (memories like a RAM and a ROM) and external storage devices of the computer, and a variety of other computer readable media.

The above and other objects, features, aspects, and advantages of the present invention will become more apparent from the following detailed description of the preferred embodiment with the accompanying drawings.

### BRIEF DESCRIPTION OF THE DRAWINGS

FIG. 1 is a block diagram showing the structure of an information collection system in one embodiment of the present invention;

FIG. 2 shows an example of structural definition;

FIG. 3 shows an electronic mail including virus-related information;

FIG. 4 is a flowchart showing an electronic mail analysis routine executed in the embodiment;

FIG. 5 shows an output example of a virus eradication record;

FIG. 6 shows an output example of a virus class list; and

FIG. 7 is a flowchart showing another electronic mail analysis routine in one modified example.

### DESCRIPTION OF THE PREFERRED EMBODIMENTS

One mode of carrying out the invention is discussed below as a preferred embodiment in the following sequence:

A. System Construction

B. Structural Definition

C. Information Extraction Process

D. Example of Aggregation

E. Effects

F. Modified Example

A. System Construction

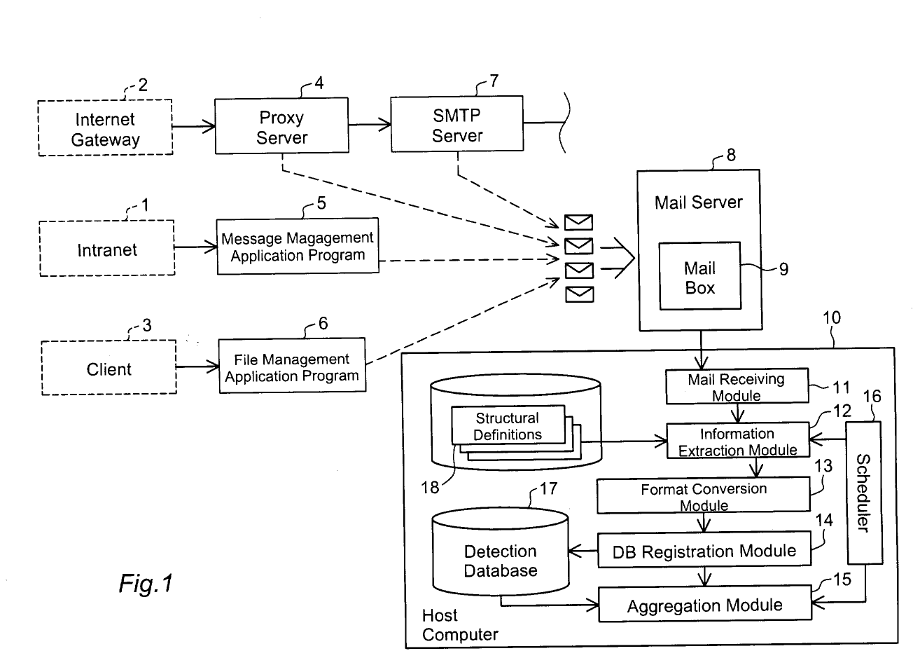

FIG. 1 is a block diagram showing the structure of an information collection system in one embodiment of the present invention. The information collection system collects virus-related information from a diversity of computers and other devices on a network by utilizing electronic mails. The information collection system of this embodiment includes a mail server 8 and a host computer 10.

In the structure of this embodiment, a virus eradicating application program installed in each device transmits an electronic mail including virus-related information. The information collection system shown in FIG. 1 includes multiple devices with the virus eradicating application program installed therein, that is, an SMTP server 7 and a proxy server 4 connecting with an Internet gateway 2 that functions to connect an intranet 1 in an enterprise to the Internet. The information collection system also has a message management application program 5 that runs on a management computer connecting with the intranet 1, and a file management application program 6 that runs on a client 3 connecting with the intranet 1. When the virus eradicating application program detects any virus, an electronic mail including virus-related information is transmitted to the mail server 8. These electronic mails are kept in a mail box 9 and processed by the host computer 10 in a periodical manner.

The host computer 10 analyzes the information included in the electronic mail. The host computer 10 has multiple functional blocks shown in FIG. 1. In this embodiment, the functional blocks are constructed by installing an information analysis program in the host computer 10. The respective functional blocks may alternatively be actualized by the hardware structure.

A mail receiving module 11 fetches an electronic mail as an object of analysis from the mail box 9. An information extraction module 12 analyzes the contents of the fetched electronic mail and extracts virus-related information. A structural definition 18 provided in advance is used for the analysis. The structural definition 18 defines the format of the virus-related information included in the electronic mail. The contents of the structural definition 18 will be discussed later in detail. The structural definition 18 may be stored inside the host computer 10 or may otherwise be read externally from a recording medium, such as a CD-ROM or via the network.

A format conversion module 13 makes the information extracted by the information extraction module 12 subjected to format conversion, for the purpose of collective registration of the information in a database. The applicable format is, for example, a CSV (comma separated value) format, in which data are arranged in a preset order of parameters with comma separation.

A database registration module 14 registers the format-converted virus-related information into a detection database 17. An aggregation module 15 statistically processes the data registered in the detection database 17 and prepares a report including, for example, virus eradicating information of past month. The administrator of the host computer 10 prints this report or distributes the report via the network to inform each user of the virus-related information.

A scheduler 16 functions to trigger periodical analysis of electronic mails and preparation of reports at preset timings. The scheduler 16 has built-in calendar information and activates the information extraction module 12 according to a preset schedule, for example, once a day or once in the morning and once in the afternoon. The scheduler 16 also activates the aggregation module 15 according to a predetermined schedule, for example, once a week or a once a month. The information extraction module 12 and the aggregation module 15 may be activated in an identical schedule or may be set individually. The schedule is not restricted to the fixed period as discussed above, but may be set as a time when non-processed information in the mail box 9 or in the detection database 17 reaches a predetermined amount.

B. Structural Definition

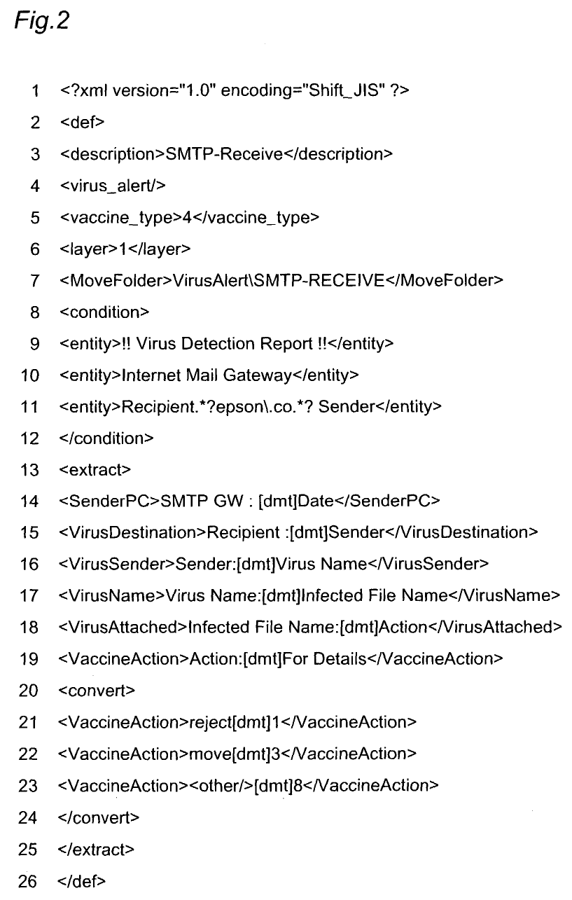

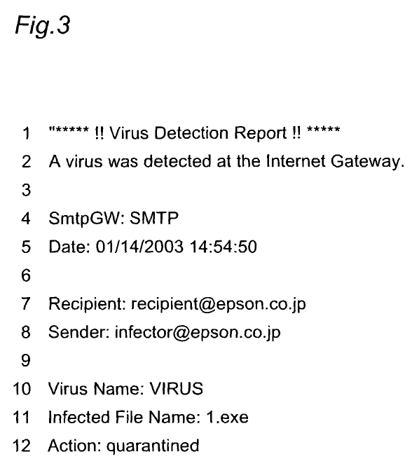

FIG. 2 shows an example of structural definition. FIG. 3 shows an electronic mail including virus-related information as an example. For convenience of explanation, line numbers are given on the left side of both the structural definition and the electronic mail. The electronic mail includes statistically non-required comment text, for example, ‘Virus Detection Report’ on the first line of FIG. 3. The structural definition is a document to specify the lines in the electronic mail, where the useful virus-related information is written. In this example, the structural definition is described in XML.

In the example of FIG. 2, the lines 8 to 12 specify conditions for application of the structural definition. The first condition is that the comment ‘Virus Detection Report’ on the line 9 and the comment ‘Internet Mail Gateway’ on the line 10 are found in the electronic mail. The line 11 defines that a domain name ‘epson.co.’ is included in letter strings described between a ‘recipient’ and a ‘sender’ in the electronic mail. In the example of the electronic mail shown in FIG. 3, the condition is that the above domain name is included in a letter string ‘recipient@epson.co.jp’ on the line 7 representing the recipient who has received a file including a virus. This structural definition is accordingly applied to process information of the virus detected in the file sent to the recipient who belongs to the above domain.

Referring back to FIG. 2, the lines 13 to 25 in the structural definition define a method of extracting information and a method of code conversion. The line 14 defines extraction of a letter string between ‘SmtpGW’ and ‘Date’, that is, extraction of a device ‘SMTP’ that has sent the virus-related information (the line 4 in the electronic mail of FIG. 3). The lines 15 to 19 successively define the method of extracting several pieces of information, that is, the recipient of a file including a virus, the sender of the file including the virus, the name of the virus, the name of the virus-infected file, and the vaccine action against the virus. In the electronic mail of FIG. 3, the information on the lines 7 to 12 is extracted according to such definition.

The lines 20 to 24 define the method of code conversion with regard to various series of virus-related processing. In this example, a ‘reject’ process, a ‘move process’, and other processes are converted to a code ‘1’, a code ‘3’, and a code ‘8’, respectively.

The structural definition is not restricted to the example of FIG. 2 but may have a diversity of other arrangements. The information to be extracted can be set arbitrarily. For example, information regarding the date and time of virus eradication may be set as the information to be extracted. The structural definition is described in XML in this embodiment, but may be described in an arbitrary language.

The format of the electronic mail including the virus-related information varies according to the virus eradicating application program. In the structure of this embodiment, multiple structural definitions are provided corresponding to multiple virus eradicating application programs. The electronic mail including the virus-related information is sent by the virus eradicating application program. The appropriate structural definition is thus selectively used according to the sender address of this electronic mail. The mapping of available sender addresses to the respective structural definitions is under management as information used for selection of the appropriate structural definition. The structural definitions may otherwise be managed individually by the sender address. A new structural definition is additionally registered every time a novel virus eradicating application program is installed in any device on the network.

C. Information Extraction Process

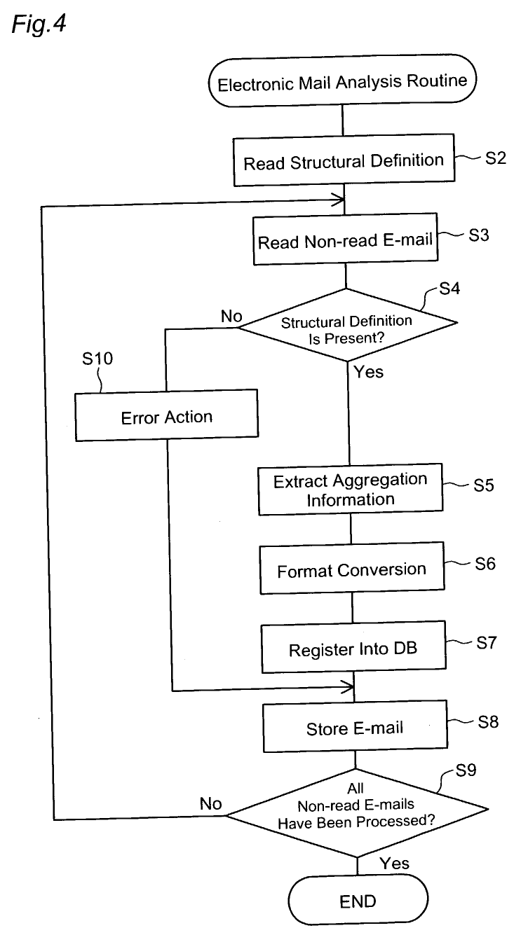

FIG. 4 is a flowchart showing an electronic mail analysis routine. This routine starts when the scheduler 16 generates a trigger at preset timings.

The host computer 10 reads the structural definition 18 provided in advance and a non-read electronic mail in the mail box 9 (steps S2 and S3), and determines whether or not a structural definition corresponding to the sender address of the electronic mail is present (step S4). In the case where the structural definition is not present, the host computer 10 carries out an error operation (step S10).

In the case where the structural definition is present, on the other hand, the host computer 10 extracts information of an aggregation object from the electronic mail, based on this structural definition (step S5), makes the extracted information subjected to the format conversion (step S6), and registers the format-converted information into the detection database 17 (step S7). One possible modification may omit the format conversion and directly add the extracted information as a record to the detection database 17.

On completion of the processing, the host computer 10 stores both the processed electronic mail after the information extraction and the electronic mail determined as error into a preset folder (step S8). One preferable method classifies the electronic mails by the sender and stores the classified electronic mails into corresponding sub-folders. The host computer 10 repeatedly executes the above series of processing with regard to all the non-read electronic mails kept in the mail box 9 (step S9).

D. Example of Aggregation

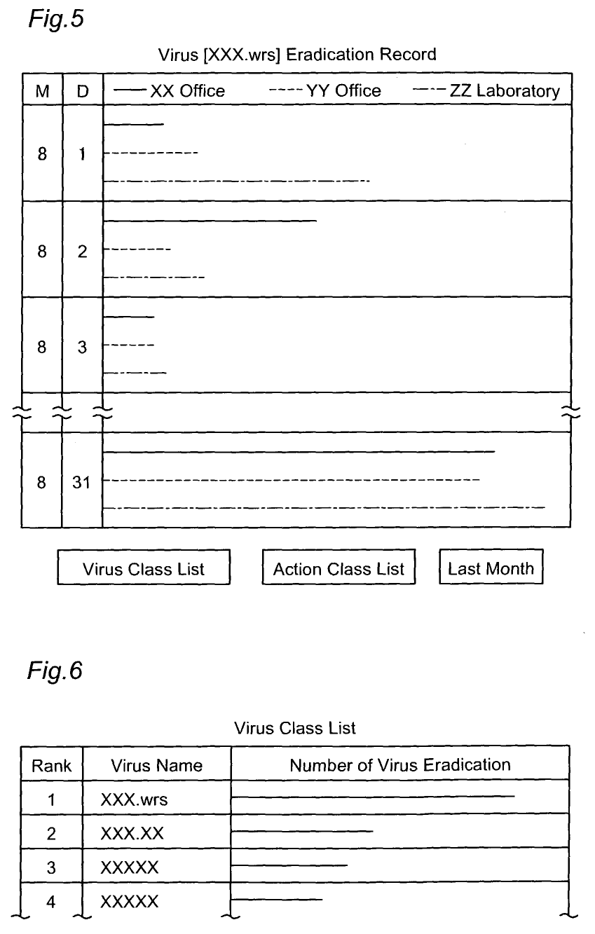

FIG. 5 shows an output example of a virus eradication record, which is output by the aggregation module 15 (see FIG. 1). This is the eradication report of a virus having the name (xxx.wrs). The number of virus eradication is plotted against the date of eradication in the form of a bar chart. The bar chart is formed to allow for comparison among offices. A click of a ‘Last Month’ button gives display of a virus eradication record of the last month. A click of an ‘Action Class List’ button gives display of an action record against each virus. A click of a ‘Virus Class List’ button gives display of various viruses eradicated in one month and the number of virus eradication.

FIG. 6 shows an output example of a virus class list. The list of various viruses is shown in a descending order of the number of virus eradication. Each number of virus eradication is shown in the form of a bar. FIGS. 5 and 6 are only illustrative and not restrictive in any sense. The virus eradication report may be output in a diversity of other forms and may include a variety of other items.

E. Effects

The system of this embodiment automatically extracts the virus-related information from the electronic mail created by the virus eradicating application program, and registers the extracted virus-related information into the database. This system selectively uses multiple structural definitions provided in advance and thereby ensures effective extraction of the virus-related information from the electronic mails of various format. The arrangement thus advantageously saves the time and the labor used for management and analyses of the virus-related information on the network.

F. Modified Example

Analysis of each electronic mail and aggregation of data may be carried out at various timings. For example, the data analysis and aggregation may be triggered by receipt of an electronic mail created by the virus eradicating application program.

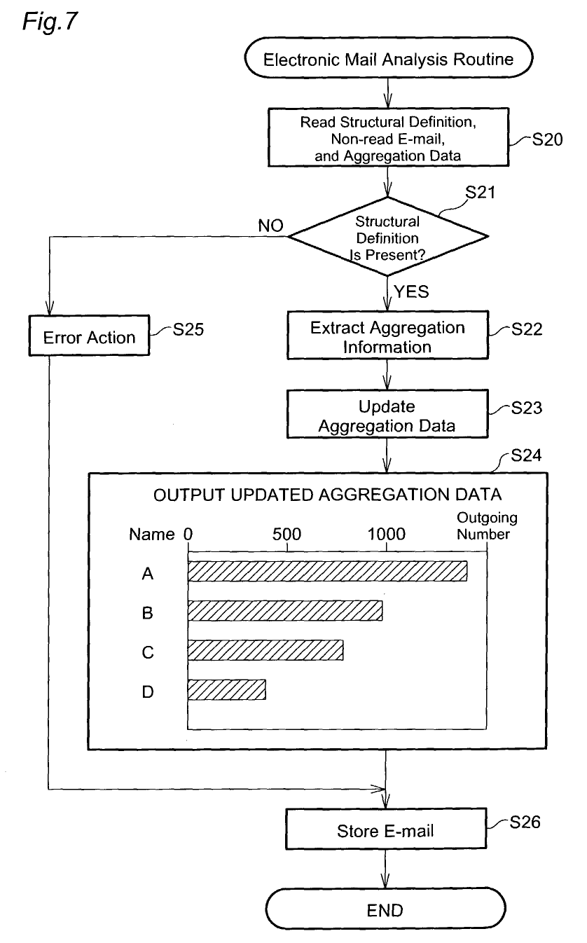

FIG. 7 is a flowchart showing another electronic mail analysis routine in one modified example. This processing routine generates aggregation data useful for identifying the sender of a virus-infected electronic mail. This processing routine is triggered by receipt of an electronic mail, which is created by the virus eradicating application program, and is executed by the host computer in an event driven manner.

The host computer 10 first reads the structural definition 18 provided in advance, a non-read electronic mail, and aggregation data (step S20). The aggregation data here represents results of a previous cycle of the processing.

When no structural definition suitable for analysis of the received electronic mail is present (step S21), the host computer 10 carries out an error action (step S25), stores the electronic mail (step S26), and exits from this processing routine, like the embodiment discussed above.

When a structural definition suitable for analysis of the received electronic mail is present (step S21), on the other hand, the host computer 10 analyzes the received electronic mail and extracts aggregation information from the analyzed electronic mal (step S22). The host computer 10 then updates the aggregation data based on the extracted aggregation information (step S23) and outputs the updated aggregation data (step S24).

An output example of the aggregation data is also shown in the flowchart of FIG. 7. The aggregation results on the number of the virus-infected electronic mails sent from each user are output in the form of a bar chart. The procedure of outputting such aggregation data extracts the sender information shown in FIGS. 2 and 3 as the aggregation information at step S22 and successively increases the number of transmission from each user corresponding to the sender information at step S23.

The host computer 10 stores the analyzed electronic mail (step S26) and exits from this processing routine. In this modified example, the aggregation data represent the number of the virus-infected electronic mails sent from each user. Another applicable procedure may aggregate the number of virus-infected electronic mails sent from the outside of the enterprise by each mail address or by each domain included in the mail address.

The aggregation data of this modified example is especially effective, for example, for the action against a certain type of the virus that automatically sends virus-infected electronic mails to all the mail addresses included in an address book stored in a client. Such aggregation data is effectively used to specify the source of infection of the virus. The arrangement of the modified example carries out the processing in the event driven manner, thus advantageously ensuring the real-time collection of the aggregation data and allowing for the prompt countermeasure against the virus.

In the embodiment and the modified example discussed above, the electronic mails including the virus-related information are not restrictive to those automatically transmitted from the virus eradicating application program. Electronic mails manually created in a predetermined format may also be objects of the analysis. In the structure of the embodiment, the function of preparing the report based on the data in the database may be omitted, if not required. The principle of the present invention is applicable to a variety of other electronic mails, as well as the electronic mails including the virus-related information, and even to mixture of electronic mails produced by different application programs for different purposes. In such cases, the structural definition may be selectively used according to the title of the electronic mail, in place of the sender address.

The functional blocks shown in FIG. 1 may be attained by separate program modules or an integrated program module. All or part of these functional blocks may be actualized by the hardware structure including logic circuits. Each program module may be incorporated in an existing application program or may be designed as an independent program. Any of these computer programs may be recorded in a computer readable recording medium, such as a CD-ROM, and installed in a computer. Alternatively the computer program may be downloaded into a memory of a computer via a network.

The above embodiment is to be considered in all aspects as illustrative and not restrictive. There may be many modifications, changes, and alterations without departing from the scope or spirit of the main characteristics of the present invention. All changes within the meaning and range of equivalency of the claims are therefore intended to be embraced therein.

The scope and spirit of the present invention are indicated by the appended claims, rather than by the foregoing description.

What is claimed is:

1. An information collection system that collects predetermined information from an electronic mail, said information collection system comprising:
a mail reading module that reads an electronic mail including the predetermined information;
a memory module that stores multiple structural definitions, which correspond to multiple formats of the electronic mail and are used to specify a place of the electronic mail where the predetermined information is described; and
an information extraction module that refers to one of the multiple structural definitions corresponding to a format of the electronic mail, and extracts the predetermined information from the electronic mail.

2. An information collection system in accordance with claim 1, wherein the format of the electronic mail is defined corresponding to identification information representing at least part of a sender, a destination, and a title of the electronic mail, and
said information extraction module refers to one of the multiple structural definitions, based on the identification information.

3. An information collection system in accordance with claim 1, wherein each of the multiple structural definitions defines at least either of letter strings to be written immediately before and immediately after the predetermined information.

4. An information collection system in accordance with claim 1, wherein each of the multiple structural definitions includes an application condition to specify propriety of application of the structural definition, based on the format of the electronic mail.

5. An information collection system in accordance with claim 1, wherein each of the multiple structural definitions includes a conversion rule, which is used to convert the predetermined information extracted from the electronic mail into a specified letter string according to contents of the extracted information, and
said information extraction module converts the predetermined information according to the conversion rule.

6. An information collection system in accordance with claim 1, wherein said memory module stores the multiple structural definitions as individual files.

7. An information collection system in accordance with claim 1, said information collection system further comprising:
an extraction control module that automatically activates said information extraction module at a preset timing.

8. An information collection system in accordance with claim 1, said information collection system further comprising:
an aggregation module that prepares predetermined aggregation data, based on the predetermined information extracted from the electronic mail.

9. An information collection system in accordance with claim 8, wherein the predetermined information regards a virus infection status,
the aggregation data represents a number of transmission of virus-infected files by each sender of the virus-infected files, and
said aggregation module starts preparation of the aggregation data, in response to an action of reading the electronic mail by said mail reading module.

10. An information collection method that collects predetermined information from an electronic mail, said method comprising the steps of:
reading an electronic mail including the predetermined information;
preparing in advance a memory module that stores multiple structural definitions, which correspond to multiple formats of the electronic mail and are used to specify a place of the electronic mail where the predetermined information is described; and
referring to one of the multiple structural definitions corresponding to a format of the electronic mail, and extracting the predetermined information from the electronic mail.

11. A computer readable medium in which a computer program that is used to collect predetermined information from an electronic mail is recorded, said computer program causing a computer to attain the functions of:
reading an electronic mail including the predetermined information;
referring to a memory module that stores multiple structural definitions, which correspond to multiple formats of the electronic mail and are used to specify a place of the electronic mail where the predetermined information is described; and
referring to one of the multiple structural definitions corresponding to a format of the electronic mail, and extracting the predetermined information from the electronic mail.
